(19) United States
(12) Patent Application Publication
(10) Pub. No.: US 2022/0045467 A1
(43) Pub. Date: Feb. 10, 2022

(54) Soldering Block for LED Tape Light

(71) Applicant: Connlaoth MulHolland, Sonoma, CA (US)

(72) Inventor: Connlaoth MulHolland, Sonoma, CA (US)

(21) Appl. No.: 17/312,865

(22) PCT Filed: Dec. 11, 2019
(86) PCT No.: PCT/US19/65680

§ 371 Date: Jun. 10, 2021

Related U.S. Application Data
(60) Provisional application No. 62/778,882, filed on Dec. 12, 2018.

(51) Int. Cl. H01R 43/02; B23K 3/08; F21V 23/00

(52) U.S. Cl. CPC H01R 43/0263; B23K 2101/40; F21V 23/001; B23K 3/087

(57) ABSTRACT

A soldering block for holding two electrical components in contact or proximity to facilitate their connection, such as by soldering. The soldering block utilizes a pair of fixation elements, such as spring tensioned clamps, to hold the first and second electrical elements in place, conveniently acting as a third hand for the electrician. The soldering block is especially well suited to connecting wires to the terminals of LED tape strip.

### CROSS-REFERENCE TO RELATED APPLICATIONS

This application is a 35 USC § 371 National Stage application of International Patent Application Number PCT/US2019/065680, entitled “Soldering Block for LED Tape Light,” filed Dec. 11, 2019, which claims the benefit of priority to U.S. Provisional Patent Application Ser. No. 62/778,882 entitled “Soldering Block for LED Tape Light,” filed Dec. 12, 2018, the contents of which applications are hereby incorporated by reference.

### BACKGROUND OF THE INVENTION

LED tape strip comes with terminals at regular intervals and can be cut to the desired length at the terminal sites. To make the tape functional, these terminals have to be connected to positive and negative wires hooked to a power source. Control wires may also need to be connected to terminals on the tape. This is a time consuming process.

Previously disclosed devices for soldering LED tape are described in PCT Patent Application Publication Number PCT/US2017/46178, entitled “Device for Soldering Wires to an LED Tape Strip.” This previously disclosed device advantageously enables soldering of LED tape strip terminals to wires by use of an integrated soldering feed and heating mechanism. However, the cost and complexity of the previously disclosed device is significant. Alternatively, solderless connectors may be used to connect wires to LED tape strip terminals. Various solderless connectors are known in the art which clamp the end of the tape strip and the wires to create an electrical connection. However, these solderless connectors are expensive, bulky, and do not create the same quality of connection that is imparted by a soldered connection.

Accordingly, there remains a need in the art for tools that facilitate the facile soldering of wires to LED tape.

### SUMMARY OF THE INVENTION

The invention encompasses a novel device for aiding the soldering of led tape strips. Provided herein is a novel tool which allows for easy connection of wires to the terminals of LED tape. The tool provides the art with a convenient means of making connections between LED tape and wires or other electrical elements.

The device of the invention comprises a soldering block which enables the fast soldering of wires to terminal pads on LED tape strips. Advantageously, the novel soldering block provides the art with a device for quick soldering of LED tape strip to power and control wires. The devices of the invention conveniently hold elements in place, freeing the user from the need of holding the elements in place by hand while simultaneously operating a soldering device. In essence, the device of the invention acts as an extra pair of hands that aids the user in precisely placing the elements and readily joining the elements.

### BRIEF DESCRIPTION OF THE DRAWINGS

FIG. 1 depicts the device of the invention in use, with wires and LED tape clamped to the soldering surface.

FIG. 2 depicts an exploded view of an exemplary device of the invention.

FIG. 3A depicts a side view of a device of the invention wherein the clamp is open to accept a wire. FIG. 3B depicts the device wherein the clamp is closed, holding the wire in place on the soldering surface.

FIG. 4 depicts a top view of the device with LED tape and wire held in place by the clamps.

FIG. 5 depicts a soldering block wherein the fixation elements comprise a pair of flexible bands.

FIG. 6 depicts a soldering block wherein the fixation elements comprise a pair of tension clips.

### DETAILED DESCRIPTION OF THE INVENTION

In a general embodiment, the device of the invention comprises a soldering block, comprising a substantially planar surface; a first fixation element for holding a first electrical elements (or group of elements) to the planar surface; and a second fixation means for holding a second electrical element (or group of electrical elements) to the planar surface, such that end(s) of the first electrical element(s) and end(s) of the second electrical element(s) is/are held in proximity to each other.

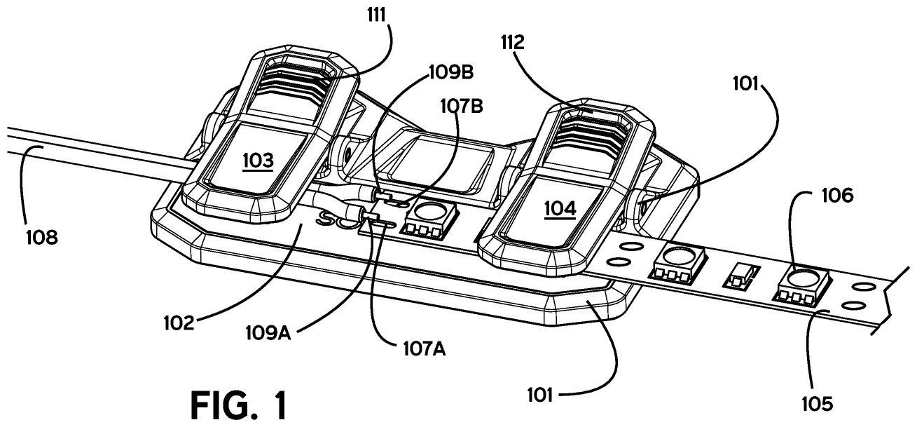

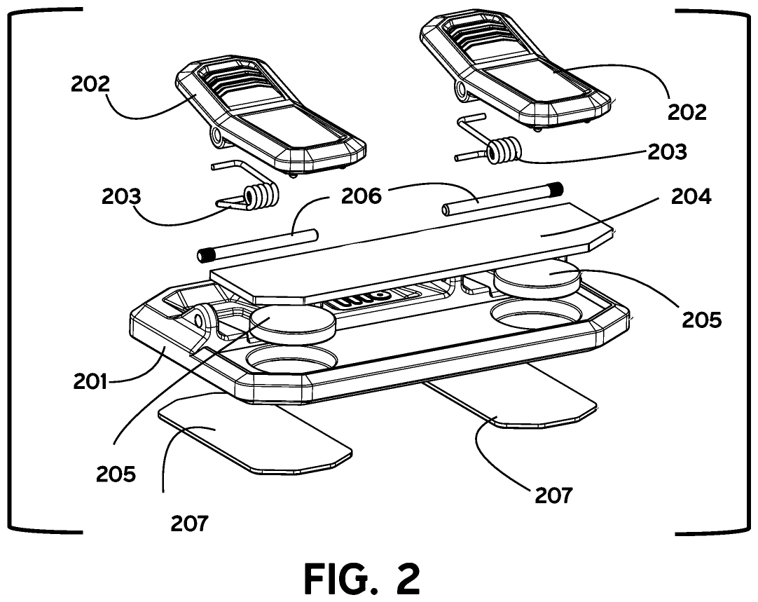

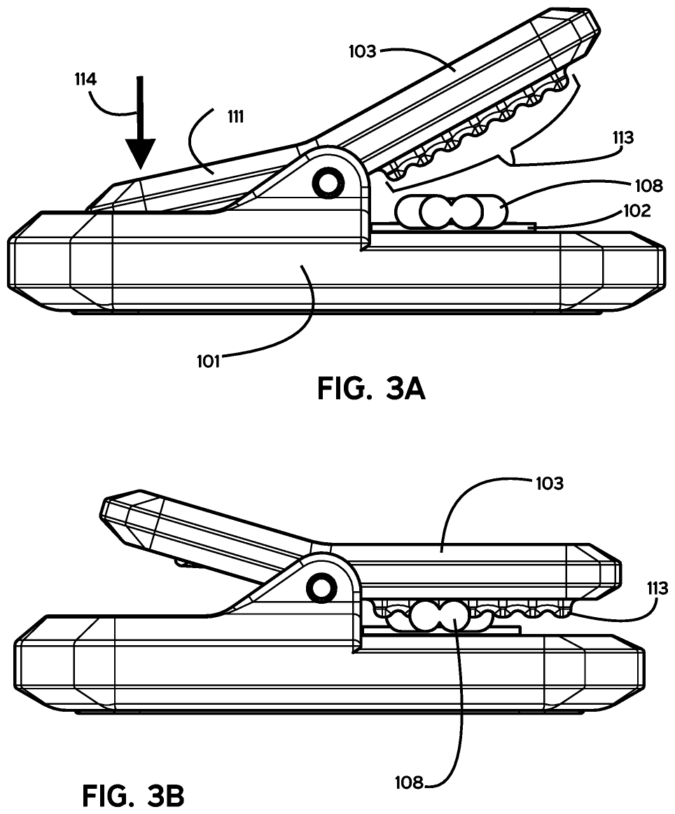

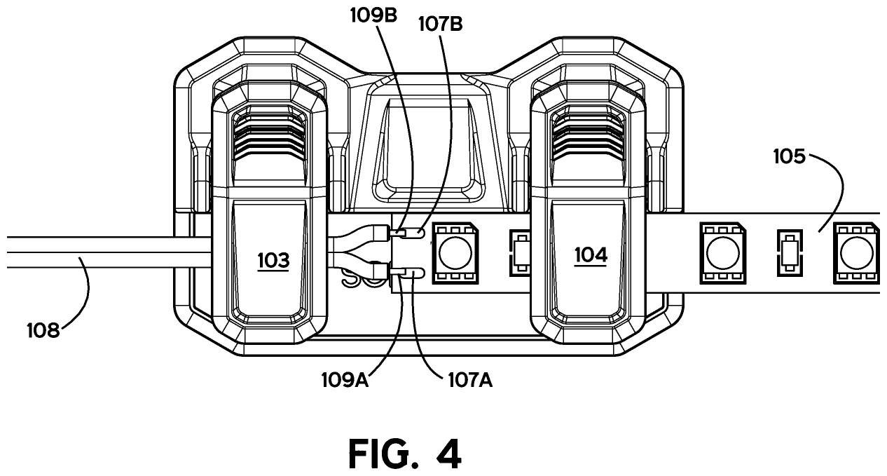

An exemplary embodiment of the invention is depicted in FIG. 1, FIG. 2, FIGS. 3A and 3B, and FIG. 4. It will be understood that these depictions are exemplary in nature and that the scope of the invention is not limited to the depicted embodiments, but extends to any device or method embodying the inventive concepts described herein.

Base.

A first element of the device is the base 101. The base will be an object such as a block, a plate, or other body comprising a top, planar surface. For example, the base may comprise a substantially rectangular body as depicted in FIG. 1. The base will comprise at least one substantially flat surface, being the planar surface on which electrical elements are held in place and soldered or otherwise connected together.

The base may comprise any material, such as plastic or other polymeric material. Exemplary plastics include, for example, polyethylene terephthalate (PET or PETE or Polyester), high-density polyethylene (HDPE), polyvinyl chloride (PVC), low-density polyethylene (LDPE), polypropylene, polystyrene, or nylon. In other implementations, the base may be made of a metal such as steel or aluminum, wood, ceramic, glass, or other materials, for example, non-conductive materials. The base may be manufactured by methods known in the art, such as injection molding, additive manufacturing, or milling.

The body will comprise a working surface, for example, a top surface which is substantially planar.

In one implementation, the top surface comprises a second body, referred to herein as a plate, that is adhered to top surface of the body or inlaid in recessed area of the base to create a working surface. In one embodiment, the body comprises a recessed area or channel in which the plate, comprising a planar body is inlaid. For example, an assembly of the device is depicted in FIG. 2 with plate element 204 fitting into the base 201, optionally with the use of magnets 205.

The plate may comprise a different material than the material of the body, for example, being a heat-resistant material that will not melt or burn when exposed to hot solder. The plate may comprise a material that is non-stick, which is resistant to bonding with hot solder. Exemplary materials for the plate include metal, ceramic material, glass material, or organic material. In various embodiments the plate comprises a metal, such as aluminum, stainless steel, titanium, or other metals. In one embodiment, the plate comprises an organic material such as cork or wood. The plate acts as a working surface for the soldering of elements and also acts to dissipate heat in order to facilitate faster cooling of solder beads. In one embodiment, a single plate is used. In alternative embodiments, two or more plates are laid side by side to create the working surface.

In alternative embodiments, the plate is omitted and the work surface comprises a material that is painted, coated, or otherwise applied to the top surface of the body to provide a working surface for soldering.

In one embodiment, the base and/or the plate comprise grooves for wires or LED tape strip to sit in.

Fixation Elements.

The body will comprise two or more fixation elements for temporarily holding the LED tape and wires in place in on the top surface of the base, e.g. the work area defined by a plate. A fixation element will comprise any structure that may apply force to an electrical element (e.g. wire or LED tape strip) such that it is held, pressed, or otherwise fixed against the working surface of the base or plate. Exemplary fixation elements include clips, clamps, hinged elements, or other structures that can be pressed down onto the electrical elements, or which the electrical elements can be slipped under. In a primary embodiment, the fixation elements comprise tensioned elements that are lifted to insert electrical elements and then lowered onto the electrical elements to hold them in place. For example, in the exemplary embodiment depicted in FIG. 1, the fixation element comprise hinged spring clamps 103 and 104 that can be raised by a user depressing levers 111 and 112.

FIG. 3A and FIG. 3B depict an exemplary fixation element of the invention comprising a spring tensioned spring clamp 103. FIG. 3A depicts the spring clamp in an open position, wherein downward force 114 is applied by the user, for example, by finger pressure, to the lever portion 111 of the spring clamp, such that the clamp is opened to receive an electrical element 108. In some implementations of the invention, the spring clamp comprises a plurality of teeth 113 or other protrusions that assist in holding the electrical element firmly on the plate 102, if present, or the top surface of the base 101. FIG. 3B depicts the spring clamp in the closed position, wherein the downward force on the lever portion 111 of the clamp has been removed and the spring tensioned clamp returns to a closed position wherein the electrical element 108 is held firmly between the plate 102 and the clamp 103, for example, with the assistance of teeth 113 on the clamping element.

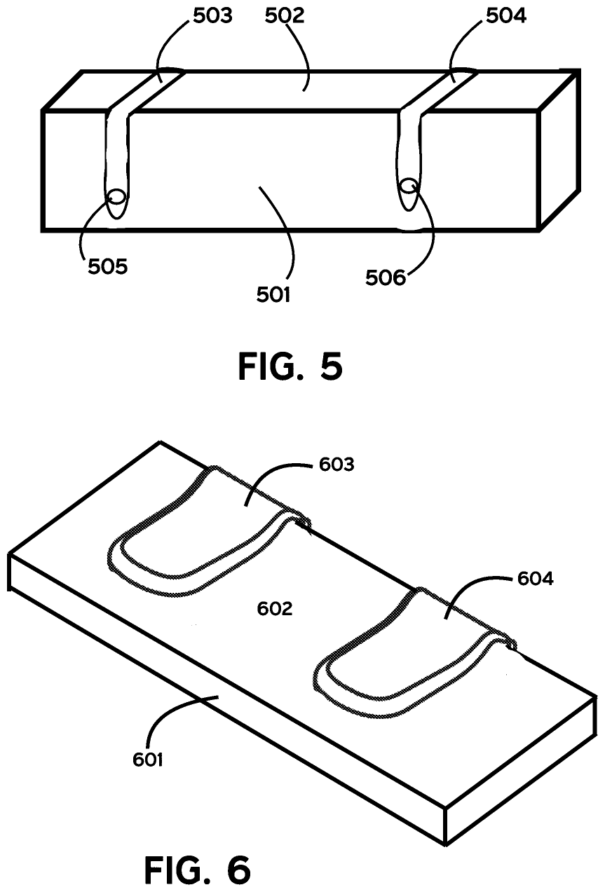

In alternative embodiments, the fixation elements comprise other structures for holding LED tape and wires in place. For example, in one embodiment, the fixation elements comprise bands or straps, such as elastic bands, under which the electrical elements are slipped and which snugly press the electrical elements to the working surface or plate. The bands may comprise any flexible material, for example, rubber, woven materials (e.g. woven nylon or polyester) or organic material such as leather. For example, as in the embodiment depicted in FIG. 5, the body 501 comprises a top surface 502 onto which electrical elements can be held in place by a pair of bands 503 and 504. Each band may be secured over the electrical element by a fastener element located at the terminal end of the band 505 and 506 and complementary fastener elements on the base. The fastener elements may comprise a snap, a hole and peg, or patches of hook and loop material (e.g. VELCRO™). In another embodiment, the structure comprises a hinged plate or bar that is lowered onto the elements to be soldered and then held in place by a clip, screw, or latch. Alternatively, in one embodiment, the fixation elements comprise a pair of tensioned clips composed of springy, elastic, or supple metal, plastic, or other material, wherein electrical elements can be slipped under the clips to hold them in place against the working surface or plate. For example, as in the embodiment depicted in FIG. 6, the body 601 comprises a top surface 602 onto which electrical elements can be held in place by a pair of tension clips 603 and 604.

In a primary embodiment, the device comprises two fixation elements, for example, a left and a right hand element, one of which will hold wires and one of which will hold the LED tape. In one embodiment, the fixation elements are substantially identical, for example, twin alligator clamps as depicted in FIG. 1. In an alternative implementation, the fixation elements are not identical, for example, they may comprise a first fixation element configured to receive wire and a second element configured to receive LED tape. In alternative embodiments, three or more fixation elements are used.

Uses of the Device.

The purpose of the device of the invention is to facilitate the connection of two electrical elements, for example, a first electrical element and a second electrical element. On one side of the device, the first electrical element is held by the first fixation element. In one implementation, the first electrical element comprise one or more separate wires (e.g. 1, 2, 3, or 4 wires) or a multistrand wire. A multistrand wire, as known in the art comprises multiple individual wires connected together or sharing a common outer jacket or insulation layer, for example, a multistrand wire comprising two, three, four, or more individual wires. In one embodiment, a multistrand wire comprises a multiple strand wire (e.g. in an outer cable housing) at the terminal end of which (e.g. the 1-10 mm end portion of which), the individual wires have been separated (or stripped of the outer jacket) and which are individually stripped at their tips, for example, stripped at the terminal 0.5 mm, 1 mm, 2 mm, 3 mm, 4 mm, 5 mm, or more to create bare metal wire sections or contact points suitable for soldering or other connections. These wire ends may are splayed to prevent their contacting each other and to align them with the terminal positions on the LED tape strip to which they are to be connected. In the case of one wire or two or more separate wires, the terminal tips of each are stripped, for example, at the terminal 0.5 mm, 1 mm, 2 mm, 3 mm, 4 mm, 5 mm, or more, to expose bare metal wire sections or contact points suitable for soldering or other connection. When held in place by the device of the invention, the wire tips of the one or more wires or multistrand wires can be positioned in contact with, or in close proximity with the appropriate terminal (proximity being a distance that is suitable for soldering, for example by a soldering gun, for example, 0.5 mm or less, 1 mm or less, 2 mm or less, 3 mm or less, etc).

On the other side of the device held by the second fixation element is a second electrical element. In one embodiment, the second electrical element or component is one or more wires or a multistrand wire, for example, to be connected to complementary wires on the other side. In one embodiment, the second electrical element is a device, for example a device comprising contacts or terminals, for example a circuit board, integrated circuit, or other electronic component. In a primary embodiment, the second electrical element is an LED tape strip, e.g. the terminal or cut end of an LED tape strip.

As used herein, “LED tape” of “LED tape strip” refers to LED strip lights, as known in the art. These devices comprise a series of light emitting diodes (LEDs), which are typically connected to a driver or controller comprising a power source and control elements. Typical driver voltages are 12 V, 24 V, or in the case of USB-driven tapes, 5 V. The tape is available in various widths, for example 2 mm, 5 mm, or 8 mm. The tapes are typically sold in long lengths (e.g. 10 5 meters), and typically comprise a 2 pairs of closely spaced terminal, i.e. electrically conductive leads, at regular intervals. The tape can be cut between the pairs of leads, resulting in a free end that can be connected to the driver or power source. The cut end of the LED tape strip will typically comprise two or three terminals.

In the case of connecting one or more wires to LED tape strip, the wires will be matched to the appropriate LED terminals (for example, any of: ground wire to ground terminal; hot wire to hot terminal; neutral wire to neutral terminal; negative wire to negative terminal; positive wire to positive terminal; and control wire to control terminal). As the wires are pliant, they may be positioned by use of fingers, pliers, or other tools to position their ends in contact with or in proximity to their appropriate terminal.

The LED tape strip is held in place using the soldering block of the invention to facilitate connection with one or more wires, wherein each of the one or more wires is connected to the appropriate terminal of the LED tape (e.g. hot wire to hot terminal, control wire to control terminal, ground wire to ground terminal, etc.). The one or more wires may comprise a multistrand wire, for example, wherein at the end of the multistrand wire, the individual wires are separated and stripped such that a length of bare metal wire is exposed for each wire of the multistrand wire.

The scope of the invention encompasses methods of using the devices described herein for the soldering of electrical components. An exemplary use of the device is depicted in FIG. 1 and FIG. 4. In this depiction, an LED tape strip 105, comprising a plurality of LEDs 106, is held in place on the base of the device 101 by the right hand clamp 104. The cut end of the LED tape strip is positioned such that the terminals of the strip 107A and 107B are present on the work surface comprising a plate 102. One or more wires 108 are held in place by the left side clamp 103. The ends of the stripped, conducing metal of each wire 109A and 109B is held in place by a fixation element on the work surface or plate, with each wire end in contact with, or in close proximity (e.g. at a distance of about 3 mm, about 2 mm, about 1 mm, or less than 1 mm, to its appropriate terminal 107A and 107B on the LED tape strip. With the elements conveniently held in place, a user may apply solder by the use of any soldering tool, such as a standard soldering gun. Any type of solder may be used in the device of the invention, for example lead solder, lead-tin solder, lead-free solder, and solder comprising flux cores. Upon application of the solder and short cooling period during which time the solder hardens, the fixation elements, for example, alligator clamps may be engaged (e.g. lifted in the case of spring clamps) to release the now-connected LED tape and wires.

It will be understood that the use of the soldering block described herein is not limited to the soldering or the soldering of LED tape strip. The device of the invention may be utilized to hold in place any components which are to be joined. Exemplary components include wires being soldered to other wires, wires being soldered to integrated circuit chips, or any other components, e.g. electrical components. Likewise, the devices of the invention may be used to join components by any means, including soldering, gluing, welding, or other contexts wherein it is useful to hold components in place for joining.

### Exemplary Embodiments

The device of the invention may be configured in various ways that encompass the use of two or more fixation elements to hold electrical elements in place for connection, for example by soldering. An exemplary embodiment of the invention is depicted in FIG. 1. An exploded view of the device of FIG. 1 is shown in FIG. 2. In this implementation, the device comprises a base 201. The base comprises a recessed area 208 configured to receive a plate 204. Optionally, the plate may comprise metal and may be held in place in the base by one or more magnets 205. In other implementations, the magnets are omitted and the plate sits in the recessed area 208 by gravity, adhesives, or complementary snap connection elements on the base and plate. The base may comprise elements 209 for affixing the fixation elements to the base, for example, a pair of knuckles 209 or like structures that receive pins 205, wherein the pins traverse knuckles 210 on the clamps 202. The clamps are tensioned by springs 203. As depicted in FIGS. 3A and 3B, the clamps may optionally comprise teeth 113. As depicted in FIG. 2, the base may comprise feet, or pads 207 on the bottom surface to prevent slippage of the device in the work area.

In one embodiment, scope of the invention encompasses a soldering block, the soldering block comprising: a substantially planar top surface; a first fixation element for holding one or more electrical elements to the planar surface; and a second fixation element for holding one or more electrical elements to the planar surface. In one embodiment, the first and second fixation elements comprise tensioned elements that sandwich the one or more electrical elements to the planar top surface. In one embodiment, the tensioned elements comprise spring clamps. In one embodiment, the spring clamps comprise a plurality of teeth. In one embodiment, the top surface of the soldering block comprises a plate, in one embodiment, the plate being inlaid in a depression or recessed area of the top surface of the soldering block. In one embodiment, the plate comprises metal, ceramic, glass, or organic material. In various embodiments, the plate comprises aluminum, stainless steel, cork, or wood.

In one aspect, the scope of the invention encompasses a method of securing a first electrical element in proximity or in contact with a second electrical element, for facilitating connecting them together (in one embodiment the connection of LED tape strip to wires), the method comprising the steps of: utilizing a soldering block, wherein the soldering block comprises: a substantially planar top surface; a first fixation element for holding one or more electrical elements to the planar surface; and a second fixation element for holding one or more electrical elements to the planar surface; wherein, in one embodiment, the first and second fixation elements comprise tensioned elements that sandwich the one or more electrical elements to the planar top surface; wherein, in one embodiment, the tensioned elements comprise spring clamps; wherein, in one embodiment, the spring clamps comprise a plurality of teeth; wherein, in one embodiment, the top surface of the soldering block comprises a plate, wherein, in one embodiment, the plate is inlaid in a depression or recessed area of the top surface of the soldering block; wherein, in one embodiment, the plate comprises metal, ceramic, glass, or organic material, wherein, in various embodiments, the plate comprises aluminum, stainless steel, cork, or wood; the method comprising the step of: securing the first electrical element to the top surface of the soldering block by the first fixation element; securing the second electrical element to the top surface of the soldering block by the second fixation element; and wherein the end of the first electrical element and the end of the second electrical element are in sufficient proximity or contact to facilitate a connection. In one embodiment, the first electrical element comprises one or more wires, for example one, two, three or four separate wires, or a multistrand wire. In one embodiment, the first electrical element comprises a multistrand wire, for example a multistrand wire at which end portion (for example, the end portion being the terminal 2 mm, 3, mm, 4 mm, 5 mm, 6 mm, 7 mm, 8 mm, 9 mm, or 1 cm of the multistrand) the individual wires have been separated, and at their tips (for example, the terminal 1 mm, 2 mm, 3 mm, 4 mm, 5 mm, or more) have been stripped of insulation to expose bare sections of wire or contact points suitable for soldering); for example, a plurality of wires or a multistrand wire comprising a negative wire, a positive wire, and optionally, a ground wire and/or control wire, or the multistrand wire comprising a hot wire and a neutral wire, and optionally, a ground wire and/or control wire, wherein the end of each wire of the the multistrand wire has separated and the tips of each wire have been stripped such that a length of bare metal wire or contact point is exposed. In one embodiment, the first electrical element comprises one or more separate wires, wherein the end of each of the one or more wires is stripped such that a length of bare metal wire is exposed. In one embodiment, the second electrical element comprises an LED tape strip, wherein the end of the LED tape strip comprises one or more terminals or contact points for connection of wires. In one embodiment, each of the exposed metal ends of the one or more wires of the first electrical element are aligned over one of the one or more terminals of the LED tape strip in contact or in such proximity that a soldering connection is readily achieved by application of a solder bead. In one embodiment, each wire and terminal is connected by soldering. In one embodiment, each wire and terminal is connected by gluing, welding, or splicing.

All patents, patent applications, and publications cited in this specification are herein incorporated by reference to the same extent as if each independent patent application, or publication was specifically and individually indicated to be incorporated by reference. The disclosed embodiments are presented for purposes of illustration and not limitation. While the invention has been described with reference to the described embodiments thereof, it will be appreciated by those of skill in the art that modifications can be made to the structure and elements of the invention without departing from the spirit and scope of the invention as a whole.

1. A soldering block, comprising
a substantially planar top surface;
a first fixation element for holding one or more electrical elements to the planar surface; and
a second fixation element for holding one or more electrical elements to the planar surface.

2. The soldering block of claim 1, wherein
the first and second fixation elements comprise tensioned elements that sandwich the one or more electrical elements to the planar top surface.

3. The soldering block of claim 2, wherein
the tensioned elements comprise spring clamps.

4. The soldering block of claim 3, wherein
the spring clamps comprise a plurality of teeth.

5. The soldering block of claim 1, wherein
the top surface comprises a plate.

6. The soldering block of claim 5, wherein
the plate comprises metal, ceramic, glass, or organic material.

7. The soldering block of claim 6, wherein
the plate comprises aluminum.

8. A method of securing a first electrical element and a second electrical element in contact with each other or in proximity to each other for facilitating connecting them together, comprising
by the use of a soldering block comprising:
a substantially planar top surface;
a first fixation element for holding one or more electrical elements to the planar surface; and
a second fixation element for holding one or more electrical elements to the planar surface
securing the first electrical element to the top surface of the soldering block by the first fixation element;
securing the second electrical element to the top surface of the soldering block by the second fixation element; and
wherein the end of the first electrical element and the end of the second electrical element are secured in sufficient proximity or contact to facilitate a connection.

9. The method of claim 8, wherein
the first electrical element comprises one or more separate wires or a multistrand wire wherein at the terminal portion of the multistrand wires, the individual wires are separated and stripped at their tips; and
the second electrical element comprises an LED tape strip comprising one or more terminals.

10. The method of claim 8, comprising
the further step of connecting the first electrical element and the second electrical element.

11. The method of claim 10, wherein
the connection is achieved by soldering, gluing, or splicing.

12. The method of claim 11, wherein
the connection is achieved by soldering.
